(19) United States
(12) Patent Application Publication
(10) Pub. No.: US 2013/0329163 A1
(43) Pub. Date: Dec. 12, 2013

(54) HIGH-CONTRAST DIRECT TYPE BACKLIGHT MODULE

(71) Applicants: PING-CHEN WU, NEW TAIPEI CITY (TW); WEI-CHUNG LIN, NEW TAIPEI CITY (TW)

(72) Inventors: PING-CHEN WU, NEW TAIPEI CITY (TW); WEI-CHUNG LIN, NEW TAIPEI CITY (TW)

(73) Assignee: UNITY OPTO TECHNOLOGY CO., LTD., NEW TAIPEI CITY (TW)

(21) Appl. No.: 13/603,688

(22) Filed: Sep. 5, 2012

(30) Foreign Application Priority Data
Jun. 8, 2012 (TW) 101120658

(51) Int. Cl. G02F 1/13357

(52) U.S. Cl. 349/64

(57) ABSTRACT

A high-contrast direct type backlight module combined, with a display module is disclosed, and the high-contrast direct type backlight module comprises a plurality of LED light sources and a diffusion plate, and the LED light sources are arranged into a matrix, and a light emitted from the LED light sources forms an elliptical light pattern on the diffusion plate separately, and the light is transmitted to the display module through the diffusion plate. Therefore, the elliptical light patterns arranged into a matrix arrangement can improve the brightness and contrast of the high-contrast direct type backlight module to optimize the resolution of the display module and provide rich color and sharp images on screen.

### CROSS-REFERENCE TO RELATED APPLICATIONS

This non-provisional application claims priority under 35 U.S.C. §119(a) on Patent Application No(s). 101120658 filed in Taiwan, R.O.C. on Jun. 8, 2012, the entire contents of which are hereby incorporated by reference.

### BACKGROUND OF THE INVENTION

1. Field of the Invention

The present invention relates to the field of backlight modules applied in liquid crystal displays, in particular to the high-contrast direct type backlight module used for enhancing the color saturation, brightness and contrast of the liquid crystal displays to provide rich effects of a screen.

2. Description of the Related Art

Since liquid crystal, display (LCD) is a passive display device without the self-emitting function, therefore it is necessary to add and install a backlight module to provide a required display light source for a display panel, and the condition whether an area light source produced by the backlight module has sufficient and uniform brightness affects the display quality of the liquid crystal display directly. At present, the backlight module can be mainly divided into two types, respectively an edge type backlight module and a direct type backlight module, wherein the direct type backlight module has the features of a high illumination uniformity, a good light-exit viewing angle, a high light energy utility rate, a simple assembly and a quick fine-tune brightness of display areas to enhance the dynamic contrast, and thus the direct type backlight module are applied extensively in large liquid crystal displays.

In addition, the LED also has the features of high light emission efficiency, long service life and low power consumption, so that the LED has become the first choice of applications to the backlight module, in general a conventional direct type backlight module has a plurality of LED light sources installed on a substrate and arranged in a matrix, and a diffusion plate is covered onto the LED light sources with an appropriate distance apart from the LED light sources for uniformly diffusing the light emitted from each of the LED light sources, so that the diffused lights can be projected onto a display panel, to provide an area light source with uniform brightness. With, reference to FIG. 1 for a schematic view of a light pattern of a conventional direct type backlight module projected on a diffusion plate, a light emitting from the LED light sources forms a circular Sight pattern 1 on the diffusion plate separately, and adjacent illuminated areas provide full-screen uniform illumination intensity. It is noteworthy that a bright portion 10 is formed with the junction of the adjacent circular light pattern 1 and a dark portion 11 is formed without any light illumination. Adjusting the light emitting power of the LED light sources varies the contrast of the bright portion 10 and the dark portion 11 to achieve the richness of the gradation and the stereopsis of the images.

To meet the market requirements of audio and video enjoyment and stimulate consumers' visual senses, it is art important and urgent subject of the present invention to further refine the grayscale of each pixel to enhance the sophistication of images on screen.

### SUMMARY OF THE INVENTION

In view of the aforementioned problems of the prior art, it is a primary objective of the present invention to provide a high-contrast direct type backlight module that improves the brightness and contrast to achieve a clear full-color display for the images on screen.

To achieve the foregoing objective, the present invention provides a high-contrast direct type backlight module combined with a display module, and the high-contrast direct type backlight module comprises a plurality of LED light sources and a diffusion plate, and after the light emitted from the LED light sources passes through the diffusion plate, the light is transmitted to the display module, and the high-contrast direct type backlight module is characterized in that the LED light sources is arranged in a matrix, and the light emitted from the LED light sources form an elliptical light pattern on the diffusion plate separately.

Wherein, each of the elliptical light patterns has a long axis and a short axis, and the long axis is parallel to a vertical line of the display module, and the short axis is parallel to a horizontal line of the display module; or each of the elliptical light patterns has a long axis and a short axis, and the long axis is parallel to a horizontal line of the display module, and the short axis is parallel to a vertical line of the display module. The display module has an aspect ratio of 16:9, which can meet the market requirements for the widescreen display specifications.

To optimize the light pattern distribution, each of the elliptical light patterns is formed by a primary optical refraction of each of the LED light sources that passes through a packaging colloid, and a distance L between the LED light sources and the display module satisfies the relation of 1 mm≦L≦50 mm. Alternately, the high-contrast direct type backlight module further comprises a plurality of light pattern ovalization means installed between the LED light sources and the diffusion plate respectively, so that after each of the light emitting from the LED light sources passes through the packaging colloid and then through each of the light pattern ovalization means to have a secondary optical refraction to form each of the elliptical light patterns. Similarly, a distance L between the LED light sources and the display module satisfies the relation of 1 mm≦L≦50 mm to uniformize the light irradiation.

Another objective of the present invention is to provide a high-contrast direct type backlight module combined with a display module, and the high-contrast direct type backlight module comprises a plurality of LED light sources and a diffusion plate. After the light emitted from the LED light sources passes through the diffusion plate, the light is transmitted to the display module. The high-contrast direct type backlight module is characterized in that the diffusion plate comprises a plurality of light pattern ovalization means installed at a light Incident position of the LED light sources that enter into the diffusion plate, and the LED light sources are arranged in a matrix. After the light emitted from the LED light sources passes through the light pattern ovalization means, an elliptical light pattern Is formed.

Wherein the light pattern ovalization means are a plurality of microlenses, and the microlenses are arranged into a matrix.

### BRIEF DESCRIPTION OF THE DRAWINGS

FIG. 1 is a schematic view of a light pattern of a conventional direct type backlight module projected on a diffusion plate;

FIG. 2 is a perspective view of a preferred embodiment of the present invention;

FIG. 3 is a schematic view of a light pattern of a high-contrast direct type backlight module of a preferred embodiment of the present invention projected on a diffusion plate;

FIG. 4 is a cross-sectional view of another preferred embodiment of the present invention;

FIG. 5 is a cross-sectional view of a further preferred embodiment of the present invention;

FIG. 6 is a cross-sectional view of another preferred embodiment of the present invention; and

FIG. 7 is a schematic view of a light pattern of another preferred embodiment of the present invention projected onto a diffusion plate.

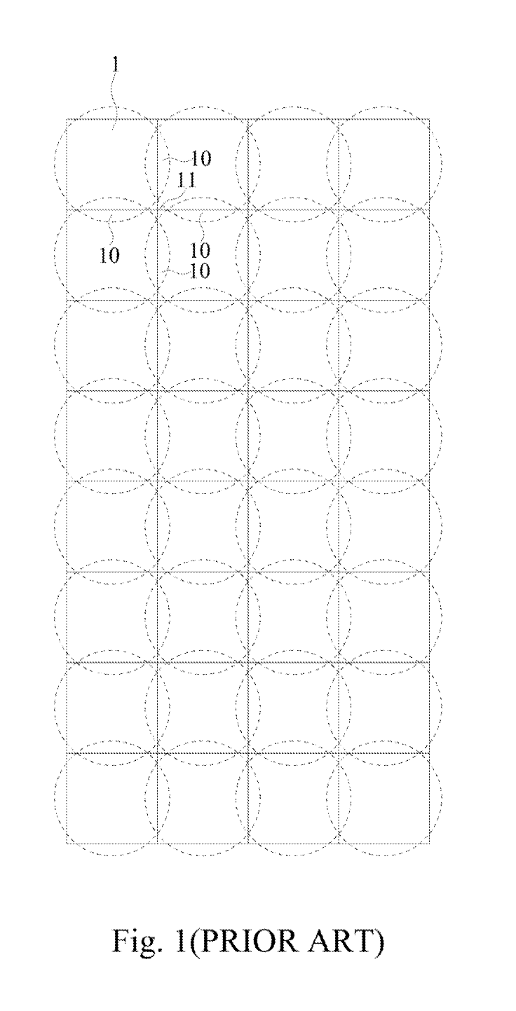

### DETAILED DESCRIPTION OF THE PREFERRED EMBODIMENTS

The technical contents of the present invention will become apparent with the detailed description of preferred embodiments and the illustration of related drawings as follows.

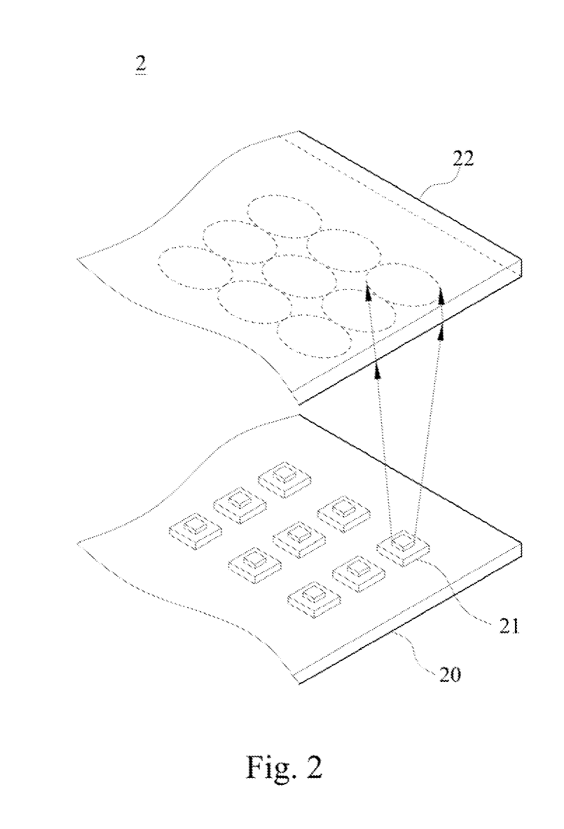

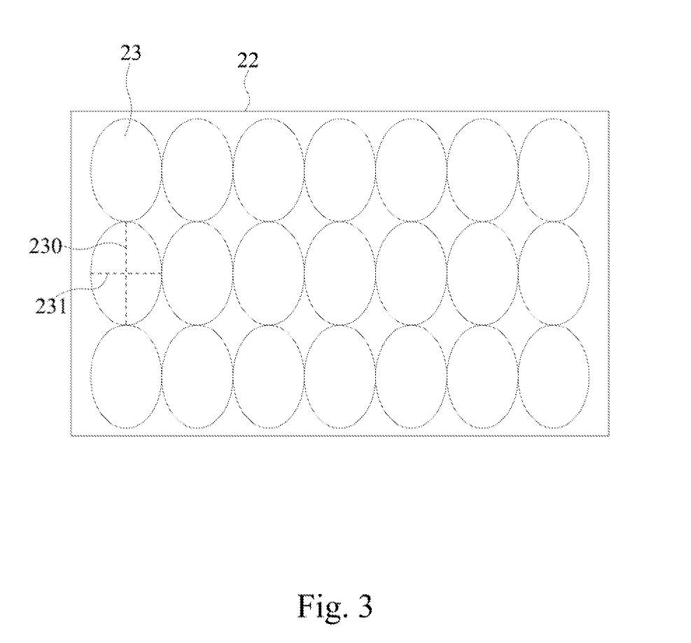

With reference to FIGS. 2 and 3 for a perspective view of a preferred embodiment of the present invention and a schematic view of a light pattern of a high-contrast direct type backlight module of a preferred embodiment of the present invention projected on a diffusion plate respectively, the high contrast direct type backlight module 2 is combined to a display module (not shown in the figure) such as a display panel of a liquid crystal display with an aspect ratio of 16:9 for providing a light source. The high contrast direct type backlight module 2 comprises a substrate 20, a plurality of LED light sources 21 and a diffusion plate 22, wherein the LED light sources 21 are arranged into a matrix and installed onto the substrate 20, and the diffusion plate 22 is covered onto the LED light sources 21 for diffusing the light emitted from the LED light sources 21 and transmitting the diffused light to the display module to provide a full-screen uniform luminance of the high contrast direct type backlight module 2. The light emitted from die LED light sources 21 forms an elliptical light pattern 23 on the diffusion plate 22 separately, and the elliptical light pattern 23 has a long axis 230 and a short axis 231, and the elliptical light patterns 23 are disposed adjacent to each other on the diffusion plate 22. In each of the elliptical light pattern 23 of this preferred embodiment, the long axis 230 is parallel to a vertical line of the display module, and the short axis 231 is parallel to a horizontal line of the display module. Since the central area of the elliptical light patterns 23 has the highest brightness along with the long axis 230, and the brightness decreases gradually towards two ends of the short axis 231, so that a relatively high brightness occurs in the vertical line of the display module. By adjusting the illumination intensity of each of the elliptical light patterns 23, the brightness and contrast between adjacent elliptical light patterns 23 can be changed to improve the grayscale of each pixel and enhance the color richness and resolution of the images on screen.

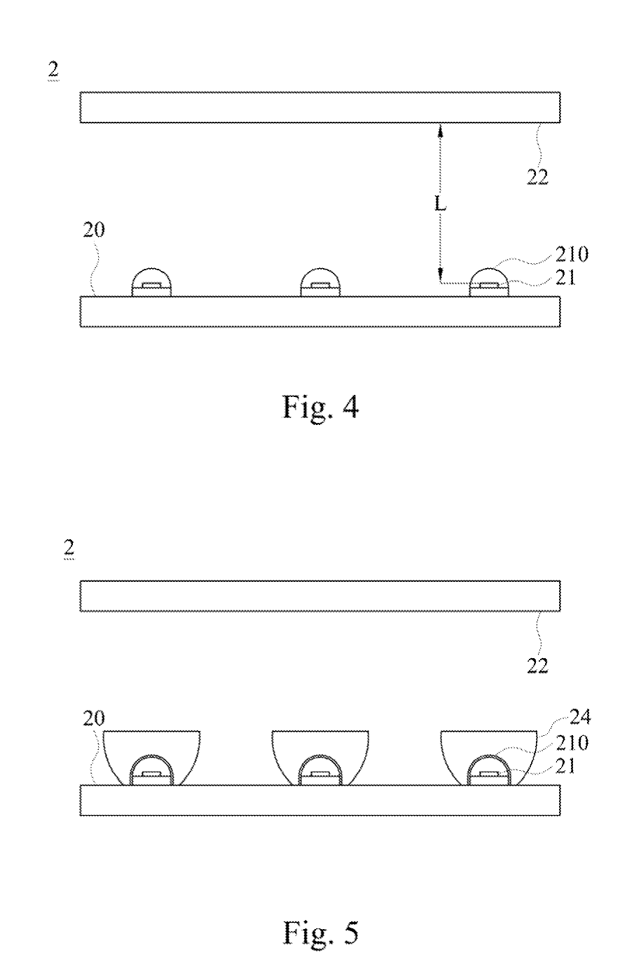

With reference to FIG. 4 for a cross-sectional view of another preferred embodiment of the present invention, each of the light emitted from the LED light sources 21 has a primary optical refraction to form each of the elliptical light patterns 23 after the light emitted from the LED light sources 21 passes through a packaging colloid 210, and a distance L between the LED light sources 21 and the display module satisfies the relation of 1 mm≦L≦50 mm to achieve the effect of umformizing the intensity of light irradiation, so as to optimize the light pattern distribution.

With reference to FIG. 5 for a cross-sectional view of a further preferred embodiment of the present invention, the high contrast direct type backlight module 2 comprises a plurality of light pattern ovalization means such as microlenses 24 installed between the LED light sources 21 and the diffusion plate 22 respectively and covered onto each of the LED light sources 21, so that after each of the light emitted from the LED light sources 21 passes through the packaging colloid 210 and then each of the microlenses 24 has a secondary optical refraction to form each of the elliptical light patterns 23. With the light pattern ovalization means, the direction of the light path and the illumination distribution of the light emitted from the LED light sources 21 can be improved to form better light patterns, so as to improve the resolution of the display module.

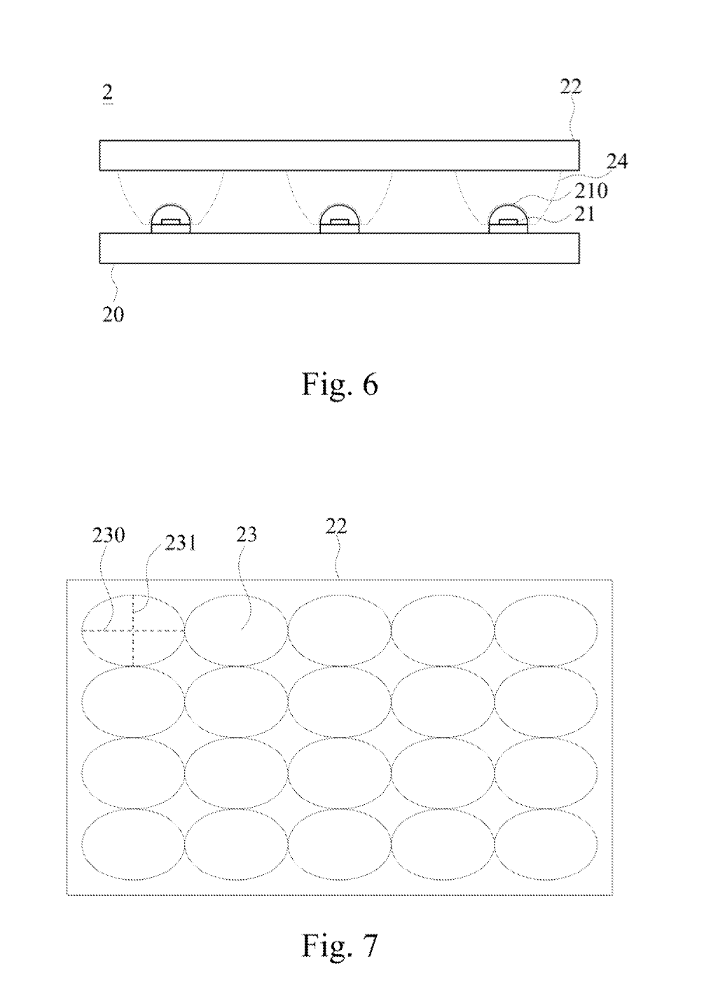

With reference to FIGS. 6 and 7 for a cross-sectional view of another preferred embodiment of the present invention and a schematic view of a light pattern of a high-contrast direct type backlight module of another preferred embodiment of the present invention projected on a diffusion plate respectively, the high contrast direct type backlight module 2 is applied in a liquid crystal display to provide a backlight source to a display module (not shown in the figure). The high contrast direct type backlight module 2 comprises a substrate 20, a plurality of LED light sources 21 and a diffusion plate 22, wherein the LED light, sources 21 arranged into a matrix are installed onto the substrate 20 and covered onto the diffusion plate 22, so that after a light emitted from the LED light sources 21 passes through the diffusion plate 22, the light is transmitted to the display module to display images on screen normally. In addition, the diffusion plate 22 includes a plurality of light pattern ovalization means such as a plurality of microlenses 24 arranged into a matrix and installed at a position of a light incident surface of the diffusion plate 22 wherein the light emitted from the LED light sources 21 are entered, so that the light of the LED light sources 21 passing through the microlenses 24 forms an elliptical light pattern 23 separately.

In this preferred embodiment, each of the elliptical light patterns 23 has a long axis 230 and a short axis 231, and the long axis 230 is parallel to a horizontal line of the display module, and the short axis 231 is parallel to a vertical line of the display module, in order to enhance the illumination intensity of the horizontal line of the display module.

What is claimed is:

1. A high-contrast direct type backlight module, combined with a display module, and the high-contrast direct type backlight module comprising a plurality of LED light sources and a diffusion plate, and a light emitted from LED light sources passing through the diffusion plate being transmitted to the display module, characterized in that the LED light sources are arranged into a matrix, and the light emitted from the LED light sources forms an elliptical light pattern on the diffusion plate separately.

2. The high-contrast direct type backlight module of claim 1, wherein each of the elliptical light patterns is formed by a primary optical refraction taken place after each of the light emitted from the LED light sources passes through a packaging colloid.

3. The high-contrast, direct type backlight module of claim 2, wherein a distance L between the LED light sources and the display module satisfies the relation of 1 mm≦L≦50 mm.

4. The high-contrast direct type backlight module of claim 1, wherein high-contrast direct type backlight module, further comprising a plurality of light pattern ovalization means installed between the LED light sources and the diffusion plate respectively, so that after each of the light emitted from the LED light source passes through the packaging colloid and then through each of the light pattern ovalization means to have a secondary optical retraction to form each of the elliptical light patterns.

5. The high-contrast direct type backlight module of claim 4, wherein a distance L between the LED light sources and the display module satisfies the relation of 1 mm≦L≦50 mm.

6. The high-contrast direct type backlight module of claim 1, wherein each of the elliptical light patterns has a long axis and a short axis, and the long axis is parallel to a vertical line of the display module, and the short axis is parallel to a horizontal line of the display module.

7. The high-contrast direct type backlight module of claim 6, wherein each of the elliptical light patterns is formed by a primary optical refraction taken place after each of the light emitted from the LED light sources passes through a packaging colloid.

8. The high-contrast direct type backlight module of claim 7, wherein a distance L between the LED light sources and the display module satisfies the relation of 1 mm≦L≦50 mm.

9. The high-contrast direct type backlight module of claim 6, wherein high-contrast direct type backlight module, further comprising a plurality of light pattern ovalization means installed between the LED light sources and the diffusion plate respectively, so that after each of the light emitted from the LED light source passes through the packaging colloid and then through each of the light pattern ovalization means to have a secondary optical refraction to form each of the elliptical light patterns.

10. The high-contrast direct type backlight module of claim 9, wherein a distance L between the LED light sources and the display module satisfies the relation of 1 mm≦L≦50 mm.

11. The high-contrast direct type backlight module of claim 1, wherein each of the elliptical light pattern has a long axis and a short axis, and the long axis is parallel to a horizontal line of the display module, and the short axis is parallel to a vertical line of the display module.

12. The high-contrast direct type backlight module of claim 11, wherein each of the elliptical light patterns is formed by a primary optical refraction taken place after each of the light emitted from the LED light sources passes through a packaging colloid.

13. The high-contrast direct type backlight module of claim 12, wherein a distance L between the LED light sources and the display module satisfies the relation of 1 mm≦L≦50 mm.

14. The high-contrast direct type backlight module of claim 11, wherein high-contrast direct type backlight module, further comprising a plurality of light pattern evaluation means installed between the LED light sources and the diffusion plate respectively, so that after each of the light emitted from the LED light source passes through the packaging colloid and then through each of the light pattern ovalization means to have a secondary optical refraction to form each of the elliptical light patterns.

15. The high-contrast direct type backlight module of claim 14, wherein a distance L between the LED light sources and the display .module satisfies the relation of 1 mm≦L≦50 mm.

16. The high-contrast direct type backlight module of claim 1, wherein the display module has an aspect ratio of 16:9.

17. The high-contrast direct type backlight, module of claim 16, wherein each of the elliptical light patterns is formed by a primary optical refraction, taken place after each of the light emitted from the LED light sources passes through a packaging colloid.

18. The high-contrast direct type backlight module of claim 17, wherein a distance L between the LED light sources and the display module satisfies the relation of 1 mm≦L≦50 mm.

19. The high-contrast direct type backlight module of claim 16, wherein high-contrast direct type backlight module, further comprising a plurality of light pattern ovalization means installed between the LED light sources and the diffusion plate respectively, so that after each of the light emitted from the LED light source passes through the packaging colloid and then through each of the light pattern ovalization means to have a secondary optical refraction to form each of the elliptical light patterns.

20. The high-contrast direct type backlight module of claim 19, wherein a distance L between the LED light sources and the display module satisfies the relation of 1 mm≦L≦50 mm.

21. A high-contrast direct type backlight module, combined with a display module, and the high-contrast direct type backlight module comprising a plurality of LED light sources and a diffusion plate, and a light emitted from the LED light sources passing through the diffusion plate being transmitted to the display module, characterized in that the diffusion plate has a plurality of light pattern ovalization means installed at a position of a light incident surface of the diffusion plate wherein the light emitted from the LEO light sources are entered, and the LED light sources are arranged into a matrix, and the light emitted from the LED light sources passes through the light pattern ovalization means to form an elliptical light pattern separately.

22. The high-contrast direct type backlight module of claim 21, wherein the light pattern ovalization means are a plurality of microlenses respectively, and the microlenses are arranged into a matrix.
